(19) United States
(12) Patent Application Publication
(10) Pub. No.: US 2006/0256137 A1
(43) Pub. Date: Nov. 16, 2006

(54) Scaling method and apparatus for displaying signals

(76) Inventor: Chenjing Fernando, Bothell, WA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/491,600

(22) Filed: Jul. 24, 2006

Related U.S. Application Data
(63) Continuation-in-part of application No. 10/027,604, filed on Oct. 19, 2001.

(51) Int. Cl. G09G 5/00

(52) U.S. Cl. 345/660

(57) ABSTRACT

A method and an apparatus for scaling display for displaying an input signal are disclosed, the method and apparatus particularly being useful for displaying return-to-zero signals. The technique includes a first step of sampling the signal. The sampled signal is searched for a zero space pattern. Then, a first zero space is located and a second zero space, following the first zero space, is located. A bit period of the input signal is calculated. Finally, the input signal is displayed using the calculated bit period as the basis for a scale.

### CROSS REFERENCE TO RELATED APPLICATION

This continuation-in-part (CIP) application claims the benefit under 35 U.S.C. Section 120 of U.S. patent application Ser. No. 10/027,604, entitled “Scaling Method and Apparatus for Displaying Signals” by Chenjing Fernando filed Oct. 19, 2001.

### BACKGROUND

The present invention relates to signal display systems. More specifically, the present invention relates to the method and apparatus for displaying signal waveforms of data transmissions.

Traditionally, in optical digital communication systems, non-return-to-zero (NRZ) modulated signals have been used at rates as fast as ten Gbs (Giga bits per second). However, as the speeds and distances for optical transmissions increase, return-to-zero (RZ) modulated signals become more desirable for various reasons. NRZ modulated signals are digital signals in which each binary value (a low or a high state represented by a zero (0) and one (1), respectively) are transmitted by a specific and constant direct-current (DC) voltage. RZ modulated signals are digital signals that, at each bit, or bit period, the value of the signal returns to zero. FIG. 1 illustrates a sample signal bit sequence “10110” sent modulated as an NRZ signal 10 and also as an RZ signal 12. A clock signal 14 is also illustrated, the clock signal dictating the period of each bit of the signals. Note that, unlike the NRZ modulated signal 10, the RZ modulated signal 12 represents a digital value “1” with a combination of high DC voltage, V_{HIGH}, for a high portion 16 (having a first duration) of a period and a low DC voltage, V_{LOW}, for a low portion 18 (having a second duration) of the period. The RZ modulated signal 10 has a duty cycle defined as a ratio of the first duration 16 to one bit period. For the purposes of illustration only, the signals 10 and 12 are illustrated as square waves.

Both the NRZ modulated and RZ modulated signals are analyzed, in part, by displaying the waveforms of the signal on an oscilloscope (“scope”), and in particular multivalue waveform display format. For example, test equipment receives an input signal (NRZ modulated or RZ modulated) and automatically scales (“autoscale”) the scope to show a multiple the waveforms (bits) of the input signal. To automatically scale the scope, the test equipment determines a range of signal strength values, typically in volts. This range is usually displayed as the Y-axis on the display. Further, the test equipment determines the period of a bit, the bit period, of the input signal. The period is typically measured in units of fractional seconds such as a picosecond (ps). Then, the measured period is used to display one or more bits of the input signal.

FIG. 2A illustrates a sample multivalue format display of an NRZ modulated input signal in an eye-diagram 11 format. In the eye-diagram 11, multiple bits (1's and 0's) are overlaid; this is illustrated using thick gray lines. The Y-axis displays the voltage ranging from V_{LOW} to V_{HIGH}. For autoscaling purposes, the voltage range is easily measurable from the input signal. As for determining the bit period to autoscale the X-axis, techniques exist to determine the bit period for NRZ modulated input signals. For example, some techniques detect subsequent NRZ transition periods to determine the bit period. However, such techniques for autoscaling the NRZ modulated signals are not well suited for RZ modulated input signals. For example, FIG. 2B illustrates a sample multivalue format display 13 of an RZ modulated signal. Note that the RZ multivalue signal 13 does not include NRZ transition periods; rather, the RZ multivalue signal 13 includes zero spaces at each bit period whereas the eye diagram 11 (NRZ multivalue signal 11) of FIG. 2A does not. A zero space is a period of time with no signal value (or data points) above certain threshold, V_{THRES}.

Accordingly, the existing NRZ autoscaling methods are ill suited to scale RZ signals. There is a need for a method and apparatus to autoscale incoming RZ modulated signals for displaying on test equipment.

### SUMMARY

These needs are met by the present invention. According to one aspect of the present invention, a method of displaying an input signal is disclosed. First, the input signal is sampled and searched for a zero space pattern. If zero space pattern is not found, then determining whether non-return-to-zero (NRZ) autoscale is applicable. If zero space pattern is found, the following steps are performed. A first zero space and a second zero space are located. Bit period of the input signal is calculated by determining time period between the first zero space and the second zero space. Finally, the input signal is displayed using the calculated bit period as the basis for a scale.

According to another aspect of the present invention, an apparatus for displaying an input signal is disclosed. The apparatus includes a processor and storage connected to the processor. The storage includes instructions for the processor perform the following operations: to sample the input signal and search for a zero space pattern in the sampled signal; to determine, if zero space pattern is not found, whether non-return-to-zero (NRZ) autoscale is applicable; to perform, if zero space pattern is found, the following: locate a first zero space; locate a second zero space, following the first zero space; calculate bit period of the input signal by determining time period between the first zero space and the second zero space; and display the input signal using the calculated bit period as the basis for a scale.

According to yet another aspect of the present invention, a machine readable medium includes program for the machine to display an input signal. The program includes instructions for the machine to: sample the input signal; search for a zero space pattern in the sampled signal; determine, if zero space pattern is not found, whether non-return-to-zero (NRZ) autoscale is applicable; perform, if zero space pattern is found, the following: locate a first zero space; locate a second zero space, following the first zero space; calculate bit period of the input signal by determining time period between the first zero space and the second zero space; and display the input signal using the calculated bit period as the basis for a scale.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 illustrates a non-return-to-zero (NRZ) modulated signal and a return-to-zero (RZ) modulated signal;

FIG. 2A illustrates an eye diagram as a multivalue diagram of an NRZ-modulated signal;

FIG. 2B illustrates a multivalue diagram of an RZ-modulated signal;

FIGS. 3A through 3D are flowcharts illustrating one embodiment of the method of the present invention;

FIGS. 4A to 4F show various sample signal configurations; and

FIG. 5 is a simplified diagram illustrating an apparatus in accordance with one embodiment of the present invention.

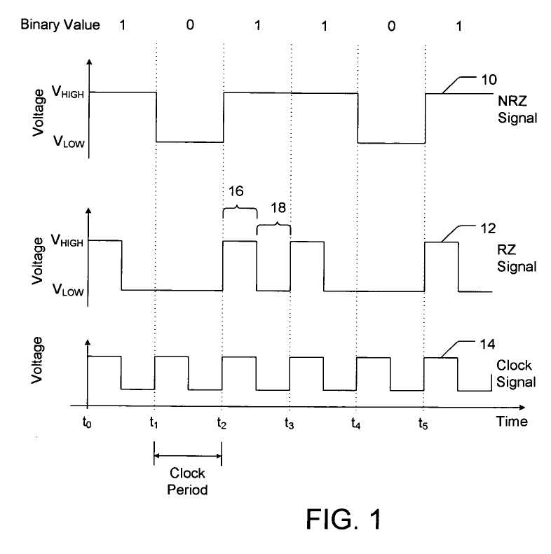

### DETAILED DESCRIPTION

As shown in the drawings for purposes of illustration, the present invention is embodied in a method of and apparatus (for example, a testing equipment) for displaying an incoming signal (“input signal”) by automatically scaling the X-axis by determining the bit period, or frequency, of the incoming signal. In summary, the technique includes a first step of sampling the signal. The sampled signal is searched for a zero space pattern. Then, a first zero space is located and a second zero space, following the first zero space, is located. A bit period of the input signal is calculated. Finally, the input signal is displayed using the calculated bit period as the basis for a scale.

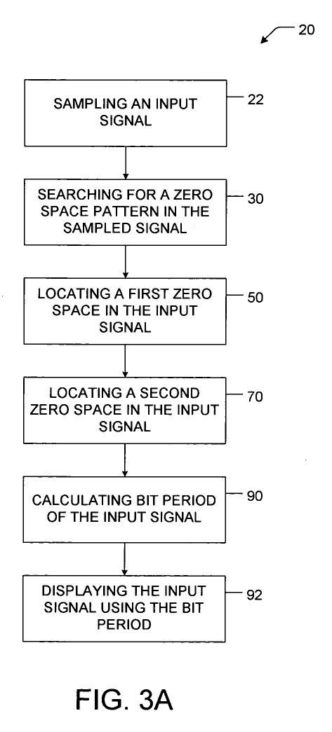

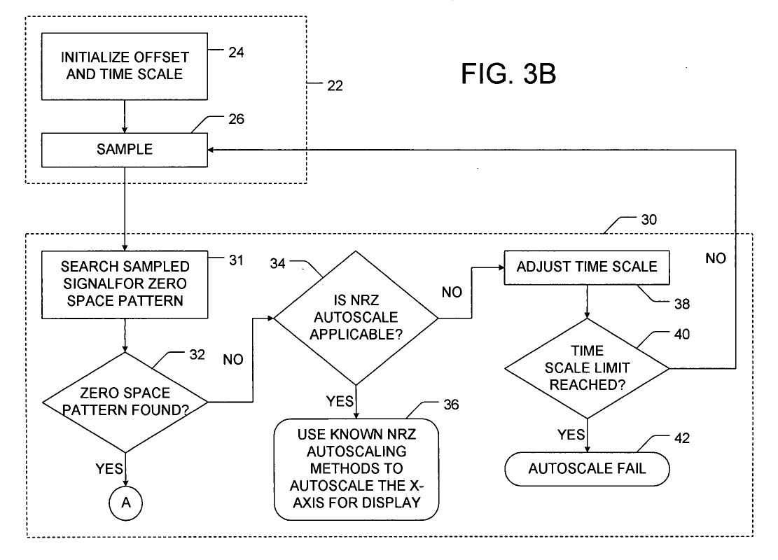

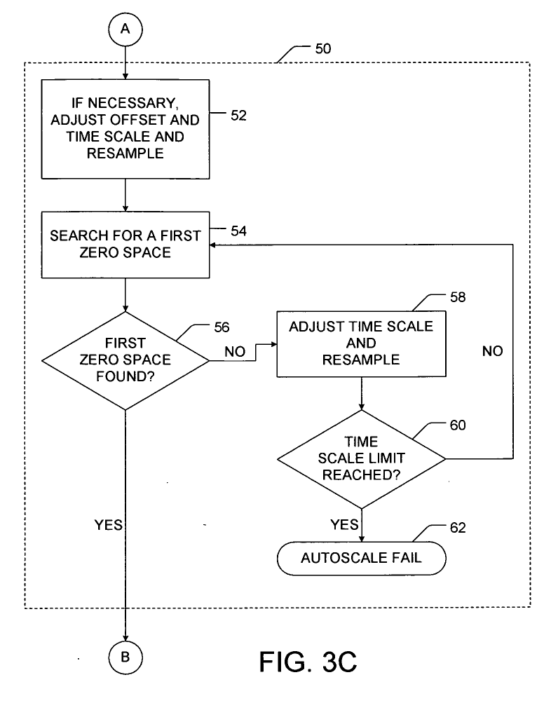

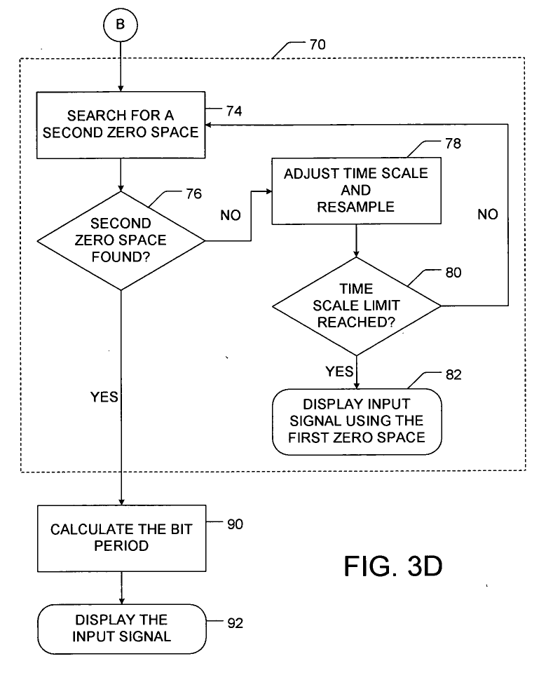

A flowchart 20 of FIG. 3A illustrates one embodiment of the technique of the present invention. Referring to FIG. 3A, an input signal is sampled. This step is illustrated using procedural step box 22 (“Step 22”). The sampled signal is searched for zero space patterns. Step 30. Then, a first zero space is located within the input signal. Step 50. Next, a second zero space is located within the input signal. Step 70. The locations of the two zero spaces are used to calculate the bit period of the input signal. Step 90. The calculated bit period is used to display the input signal. Step 92. FIGS. 3B to 3D illustrates the flowchart 20 of FIG. 3A in more detail.

Sampling the Input Signal

Referring to FIG. 3B, the step 22 of FIG. 3A is illustrated using dashed box 22 of FIG. 3B comprising a step of initializing an offset. Step 24. For example, assume that the input signal is introduced to the testing equipment at some initial instant in time, T₀. Then, the testing equipment begins to sample beginning at some offset, T_{OFFSET}, from T₀. The sample represents a segment of the incoming signal, the segment is referred to as the sampled signal. An initial scale, T_{SCALE} of some predetermined period is set, for example, at two picoseconds, 2 ps. Then, a number of samples are taken from T_{OFFSET} for a duration, T_{DURATION}, that is a multiple of the scale. Step 26. For example, if 3,000 samples are taken, for a duration of ten times the T_{SCALE}, then samples are taken at intervals of 6.67e-3 ps that is calculated as
T_{INTERVAL}=(2 ps*10)/3,000
Search For a Zero Space Pattern

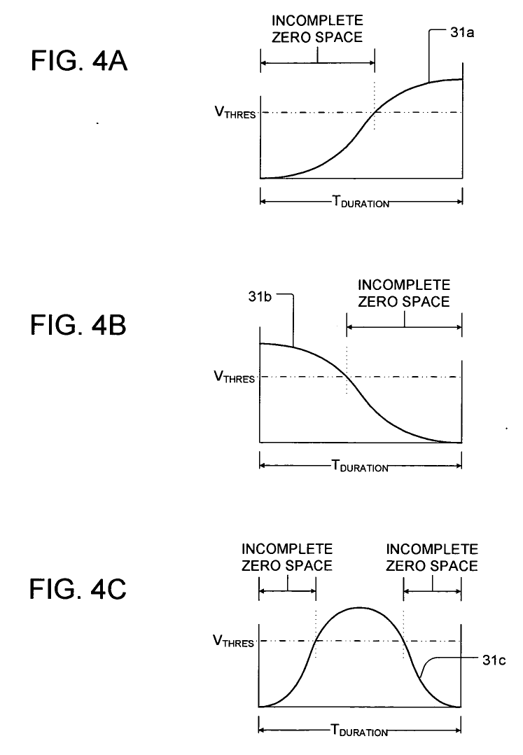

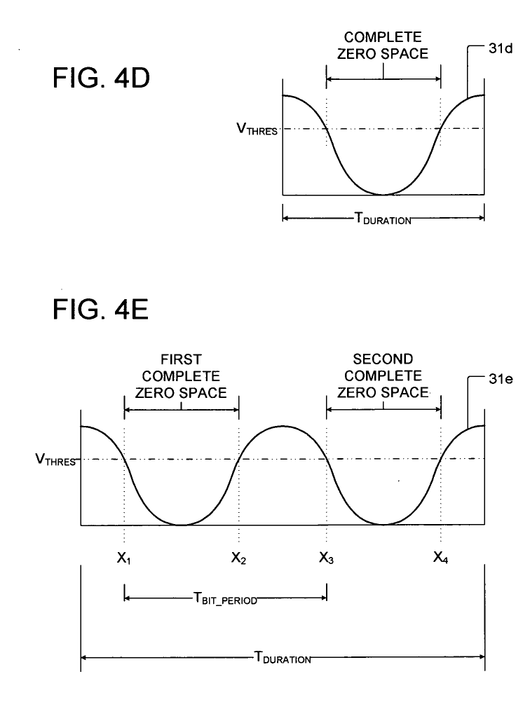

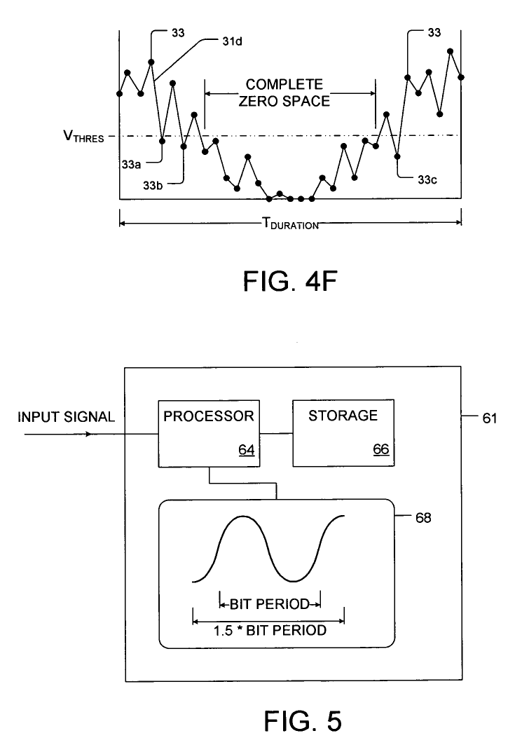

The step 30 of FIG. 3A is illustrated using dashed box 30 of FIG. 3B including more detail. The sampled signal is examined and searched for zero space patterns. Step 31 of FIG. 3B. Possible zero space patterns of the sample signal are illustrated using FIGS. 4A through 4D. Referring to FIG. 4A, a sampled signal 31a is illustrated having an incomplete zero space pattern. FIGS. 4B and 4C illustrate other sampled signals 31b and 31c, respectively, with other incomplete zero space patterns. FIG. 4D illustrates another sampled signal 31d. Here, the sampled signal 31d has a complete zero space pattern as illustrated. The sampled signal, in general, may have no zero space pattern, one or two incomplete zero space patterns, one or more complete zero space patterns, or a combination of complete and incomplete zero space patterns. FIG. 4E illustrates a sampled signal 31e having two complete zero space patterns.

FIG. 4F illustrates the sampled signal 31d in more detail including sample data points 33. To avoid clutter, only some of the sample data points are designated using the reference numeral 33. As illustrated, due to jitter, noise, or other undesired electronic effects, some sampled data points 33 may cross the threshold, V_{THRES}, and yet do not actually indicate the beginning of a zero space. For example, each of data points 33a, 33b, and 33c cross the threshold, V_{THRES}, relative to a data point immediately preceding the subject data point; however, such crossing does not indicate the beginning or the ending of a zero space. Rather, for the purposes of the present invention, the zero space is a period of time within which a minimum number of consecutive data points are below the threshold.

Depending on the application or the implementation, the minimum number of data points may be a fixed number or a percentage of the total number of data points sampled. For example, in the illustrated sample graph, the total number of sampled points is 33. Here, the minimum number of data points below the threshold, V_{THRES}, used to define the zero space is 20 percent, or seven.

Accordingly, in the illustrated sample, points such as 33a, 33b, and 33c would not trigger or otherwise lead to finding of a zero space. Such is the correct result. In real life applications, the total number of data points sampled may be in the order of thousands or tens of thousands, and the percentage of the total number of data points to determine the minimum number of data points used in locating the zero space may range from ten to thirty percent, for example, twenty percent.

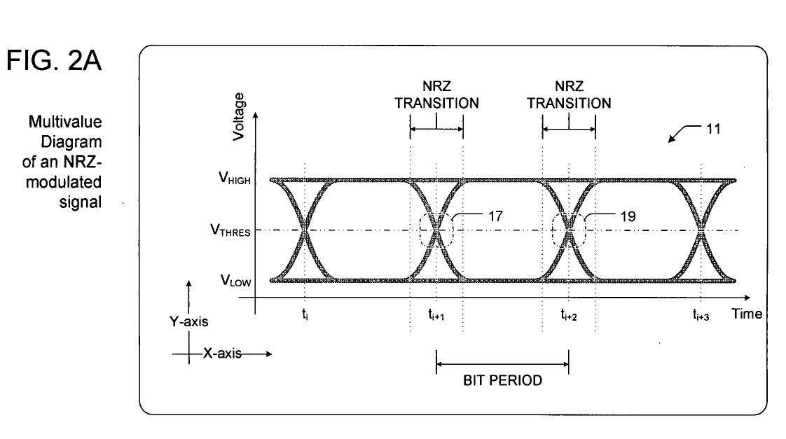

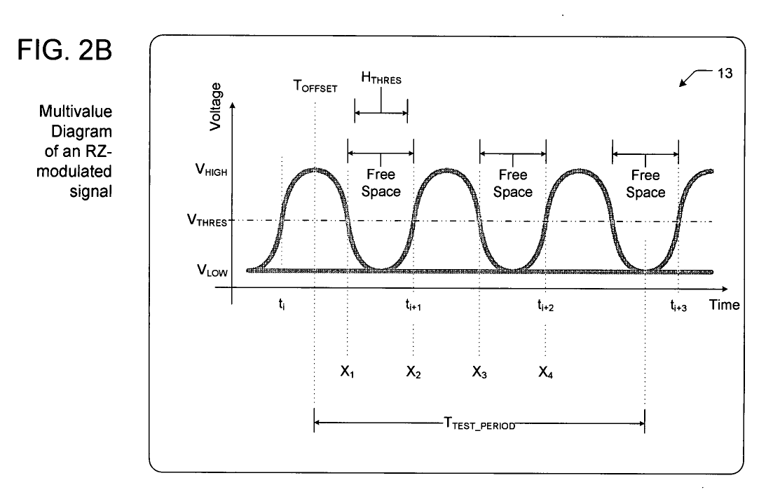

Referring again to FIG. 3B, if a zero space is not found within the sample signal (decision step 32), then the sample signal is tested for applicability of NRZ modulated signal autoscaling methods. Decision Step 34. The test for applicability of NRZ modulated signal autoscaling methods is known in the art. For example, such test involves locating two consecutive crossing regions in an eye diagram. The crossing regions are illustrated by FIG. 2A using reference numbers 17 and 19. When these two regions are detected, the period of the NRZ signal, for the purposes of autoscaling, is the distance, in the temporal scale, between these two regions.

If the NRZ modulated signal autoscaling methods are applicable, then the NRZ modulated signal autoscaling techniques are used to autoscale the X-axis for displaying the input signal. Step 36. Various techniques are known in the art to autoscale and display NRZ modulated signals and are implemented in instruments such as Agilent 83480A Digital Communication Analyzer by Agilent Technologies, Inc. and Tektronix CSA8000 Digital Sampling Oscilloscope by Tektronix, Inc.

If the NRZ modulated signal autoscaling methods are not applicable, then the scale is adjusted (step 38), samples taken with the adjusted scale (Step 26), and the steps 31, 32, and 34 are repeated. To adjust the scale, the current scale can be increased by 50 percent. For example, if the current scale, T_{SCALE}, is increased from two picoseconds to three picoseconds. However, if the adjusted scale is equal to or greater than a limit, then the autoscale operation terminates. Steps 40 and 42.

Locate a First Zero Space

If a zero space is found within the sample signal at decision step 32, then the zero space is located within the sampled signal. Step 50 of FIG. 3A. The step 50 of FIG. 3A is illustrated in more detail in FIG. 3C and is connected to FIG. 3B via connector A. Referring to FIG. 3C, the offset and the time scale are adjusted, if necessary. Step 52. For example, if the sampled signal had only incomplete zero space, then adjustments of the offset, time scale, or both may be necessary. If the adjustments are made, then the input signal is re-sampled.

The sampled (or re-sampled) signal is searched for a first zero space. Step 54. If found, the first zero space is defined by a first transition X₁ and a second transition X₂. The first transition X₁ and the second transition time X₂ of the first zero space are illustrated in FIG. 4E. If the first zero space is not found, decision step 56, then the time scale is adjusted and the input signal is sampled again. Step 58. For example, the time scale can be increased by 50 percent. Then, the steps 54 and 56 are repeated. If the adjusted time scale is equal to or greater than a limit, then the autoscale operation terminates. Steps 60 and 62. The first transition, X₁ is where value of the input signal is more than a threshold value, V_{THRES}, before the first transition, X₁, but less than the threshold value, V_{THRES}, after the first transition, X₁. The first transition, X₁, is the first such transition following the offset. The second transition, X₂, is where value of the input signal is less than the threshold value, V_{THRES}, before the second transition, X₂, but more than the threshold value, V_{THRES}, after the second transition, X₂, the second transition, X₂, being the first such transition following the first transition, X₁.

Locate a Second Zero Space

If the first zero space is found within the sample signal at decision step 56, then the sampled signal is searched for a second zero space. Step 70 of FIG. 3A. The step 70 of FIG. 3A is illustrated in more detail in FIG. 3D and is connected to FIG. 3C via connector B. Referring to FIG. 3D, the sampled (or re-sampled) signal is searched for the second zero space. Step 74. If found, the second zero space is defined by a third transition, X₃, and an fourth transition time X₄. The third transition, X₃, is where value of the input signal is more than a threshold value, V_{THRES}, before the third transition, X₃, but less than the threshold value, V_{THRES}, after the third transition, X₃. The third transition, X₃, is the first such transition following the second transition, X₂. The fourth transition, X₄, is where value of the input signal is less than the threshold value, V_{THRES}, before the fourth transition, X₄, but more than the threshold value, V_{THRES}, after the fourth transition, X₄, the fourth transition, X₄, being the first such transition following the third transition, X₃.

If the second zero space is not found, decision step 76, then the time scale is adjusted and the input signal is sampled again. Step 78. For example, the time scale can be increased by 50 percent. Then, the steps 74 and 76 are repeated. If the adjusted time scale is equal to or greater than a limit (decision step 80), then the input signal is displayed using the scale from the first zero space only. Step 82. That is, the bit period is set as the duration of the first zero space, for X₂−X₁. Then, the time scale (X-axis) is set at some multiple of the but period, for example, 1.5 times the bit period when displaying the input signal.

Calculate the Bit Period and Display the Input Signal

If the second zero space is found within the sample signal at decision step 76, then bit period is calculated as period X₃−X₁. Step 90. Then, the time scale (X-axis) is set at some multiple of the but period, for example, 1.5 times the bit period when displaying the input signal to ensure that a complete period is displayed. Step 92.

Apparatus and Medium

FIG. 5 illustrates an apparatus 61 according to one embodiment of the present invention. The apparatus 61 includes a processor 64 and storage 66 connected to the processor 64. Also connected to the processor 64 is a display 68. The storage 66 includes instructions for the processor to implement the present inventive technique including instructions for the processor 61 to sample the input signal; to search for a zero space pattern in the sampled signal; to locate a first zero space; to locate a second zero space, following the first zero space; to calculate bit period of the input signal; and to display the input signal using the calculated bit period as the basis for a scale.

The storage 66 is typically a machine readable medium such as a magnetic disc, optical disc, read only memory (ROM), random access memory (RAM), harddrive, compact disc (CD), flash memory, and solid state memory.

Although specific embodiments of the invention have been described and illustrated, the invention is not to be limited to the specific forms or arrangements of parts so described and illustrated. The invention is limited only by the claims.

What is claims is:

1. A method of displaying an input signal, the method comprising:
sampling the input signal;
searching for a zero space pattern in the sampled signal;
determining, if zero space pattern is not found, whether non-return-to-zero (NRZ) autoscale is applicable;
performing, if zero space pattern is found, the following:
locating a first zero space;
locating a second zero space, following the first zero space;
calculating bit period of the input signal by determining time period between the first zero space and the second zero space; and
displaying the input signal using the calculated bit period as the basis for a scale.

2. The method recited in claim 1 further comprising initializing offset and time scale.

3. The method recited in claim 1 wherein the step of locating the first zero space comprises wherein the first zero space is a period of time within which a minimum number of consecutive data points are below the threshold, the beginning and the ending of the period of time designated X₁ (first transition) and X₂ (second transition).

4. The method recited in claim 3 wherein the step of locating the second zero space comprises wherein the second zero space is another period of time within which a minimum number of consecutive data points are below the threshold, the beginning and the ending of the period of time designated X₃ (third transition) and X₄ (fourth transition).

5. The method recited in claim 4 wherein the step of calculating the bit period comprises determining temporal difference between the third transition, X₃, and the first transition, X₁.

6. The method recited in claim 1 further comprising displaying the input signal using a multiple of the calculated bit period as the scale.

7. An apparatus for displaying an input signal, the apparatus comprising:
a processor;
storage connected to the processor, the storage including instructions for the processor to:
sample the input signal;
search for a zero space pattern in the sampled signal;
determine, if zero space pattern is not found, whether non-return-to-zero (NRZ) autoscale is applicable;
perform, if zero space pattern is found, the following:
locate a first zero space;
locate a second zero space, following the first zero space;
calculate bit period of the input signal by determining time period between the first zero space and the second zero space; and
display the input signal using the calculated bit period as the basis for a scale.

8. The apparatus recited in claim 8 wherein the storage further comprises instructions for the processor to initialize offset and time scale.

9. The apparatus recited in claim 8 wherein the storage further comprises instructions for the processor to locate the first zero space by determining a period of time within which a minimum number of consecutive data points are below the threshold, the beginning and the ending of the period of time designated X₁ (first transition) and X₂ (second transition).

10. The apparatus recited in claim 9 wherein the storage further comprises instructions for the processor to locate the second zero space by determining another period of time within which a minimum number of consecutive data points are below the threshold, the beginning and the ending of the period of time designated X₃ (third transition) and X₄ (fourth transition).

11. The apparatus recited in claim 10 wherein the storage further comprises instructions for the processor to determine temporal difference between the third transition, X₃, and the first transition, X₁.

12. The apparatus recited in claim 11 wherein the storage further comprises instructions for the processor to display the input signal using a multiple of the calculated bit period as the scale.

13. A machine readable medium comprising program for the machine to display an input signal, the program comprising instructions for the machine to:
sample the input signal;
search for a zero space pattern in the sampled signal;
determine, if zero space pattern is not found, whether non-return-to-zero (NRZ) autoscale is applicable;
perform, if zero space pattern is found, the following:
locate a first zero space;
locate a second zero space, following the first zero space;
calculate bit period of the input signal by determining time period between the first zero space and the second zero space; and
display the input signal using the calculated bit period as the basis for a scale.

14. The medium recited in claim 13 wherein the medium is selected from a group consisting of magnetic disc, optical disc, read only memory (ROM), random access memory (RAM), harddrive, compact disc (CD), flash memory, and solid state memory.
